(19) United States
(12) Patent Application Publication
(10) Pub. No.: US 2009/0265693 A1
(43) Pub. Date: Oct. 22, 2009

(54) METHOD AND SYSTEM FOR TEST RUN PRIORITIZATION FOR SOFTWARE CODE TESTING IN AUTOMATED TEST EXECUTION

(75) Inventor: Ben Bakowski, Romsey (GB)

Correspondence Address: IBM-ACC-Washington;c/o Myers Dawes Andras & Sherman, LLP, 19900 MacArthur Blvd., 11th Floor, Irvine, CA, 92612, US

(73) Assignee: International Business Machines Corporation, Armonk, NY (US)

(21) Appl. No.: 12/106,191

(22) Filed: Apr. 18, 2008

(51) Int. Cl. G06F 9/44

(52) U.S. Cl. 717/131

(57) ABSTRACT

A method and system for software code testing for an automated test execution environment is provided. Testing involves importing test case information into a tooling environment based on code coverage and targeted testing, the test information including test name and code coverage data including classes and methods exercised by the code; generating a test hierarchy by analyzing the individual test case information; selecting tests including one or more of: all tests for a full regression run, a subset of tests for basic quality assurance or testing a particular area of functionality, and tests that exercise a recently changed class; executing selected tests to generate a pass/fail result for each test and correlating the test results; performing test run prioritization to recommend which remaining tests to execute.

### BACKGROUND OF THE INVENTION

1. Field of the Invention

The present invention relates generally to software testing and in particular to automated software code testing.

2. Background Information

The rapidly increasing complexity of software code has enhanced the need for successful test strategies to improve quality. One such strategy is regression testing, in which tests are regularly run against milestone builds of a software product codebase to detect regressions, i.e., breaking of existing functionality. Success in regression testing relies on regressions being found, isolated, and fixed quickly, preventing code instabilities from aggregating and leading to quality degradation.

There is, consequently, a significant drive to improve the efficiency of a regression test, though significant problems remain when testing complex software. Typically, a regression bucket contains thousands of individual test cases, many of which may fail when exposed to multiple defects. It is impractical to analyze all failures as it is simply too resource-intensive. A risk-based approach is commonly employed, in which the tester assesses which test failures to address first. If multiple test failures are potentially caused by the same defect, one test case is analyzed to avoid duplication of effort. Where possible, the simplest tests are selected for analysis. Though defects are flushed out, selecting which test failures to analyze requires a deep understanding of the product and test codebases.

Further, executing thousands of test permutations against all product builds is generally unfeasible due to the sheer hardware and time resources required. Instead, a common practice is to run a subset of suites first to assess general product quality, before proceeding to execute further in-depth tests to probe more deeply. Interpretation of these preliminary results requires the tester to possess significant insight into the product and test code.

Conventional testing tools attempt to improve test efficiency by providing approaches to help identify test cases to run. These approaches, often based on code coverage, broadly fall into three categories. A first approach maximizes code coverage by determining the code coverage provided by each test case, wherein test cases can be executed in an order to maximize overall coverage with as few tests as possible. Regression defects are exposed earlier, but most complex tests provide the highest code coverage and hence are recommended first. Any defects found using this approach may therefore be difficult to analyze.

A second approach involves targeted testing wherein each new product build contains incremental changes to its code base. By analyzing these changes, and correlating test cases that probe these changes, a recommendation of which tests to execute can be made. However, there is no scope for considering analysis of the results themselves. A third approach utilizes historical results and makes recommendations using test case track records in yielding defects. However, this approach offers little over conventional regression testing techniques.

### SUMMARY OF THE INVENTION

The invention provides a method and system for Test Run Prioritization (TRP) in software code testing for an automated test execution environment. One embodiment involves prioritizing execution tests in a regression bucket, based on dynamic analysis of incoming results. Further tests are run that facilitate locating the source of a defect, while tests that are expected to fail with the same problem as already observed will not be executed. One implementation involves importing test case information into a tooling environment based on code coverage and targeted testing, the test information including test name and code coverage data including classes and methods exercised by the code; generating a test hierarchy by analyzing the individual test case information; selecting tests including one or more of: all tests for a full regression run, a subset of tests for basic quality assurance or testing a particular area of functionality, and tests that exercise a recently changed class; executing selected tests to generate a pass/fail result for each test and correlating the test results; and performing test run prioritization to recommend which remaining tests to execute.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows an example import process involving importing test cases into a tooling environment 14, according to the invention.

FIG. 2 shows an example test case execution process, according to the invention.

FIG. 3 shows an example regression scenario, according to the invention.

FIG. 4 shows an example test case hierarchy, according to the invention.

FIG. 5 shows example Test Run Prioritization (TRP) information, according to the invention.

FIG. 6 shows another test hierarchy for several test cases in the regression bucket.

FIG. 7 shows a functional block diagram of a process for determining software test case complexity, according to an embodiment of the invention.

FIG. 8 shows a functional block diagram of a process for determining test case hierarchy based on complexity, according to an embodiment of the invention.

### DESCRIPTION OF THE PREFERRED EMBODIMENTS

The invention provides a method and system for software code testing for an automated test execution environment. The testing is based on code coverage, wherein test cases are recognized not to be mutually exclusive units, but instead are correctly treated as a hierarchy of functional coverage. By understanding this hierarchy, test failures can be used to infer properties about potential defects. Further, automated regression runs are made more efficient by preventing execution of tests that cover known failures. The invention further provides targeted testing for analyzing and interpreting test failures. Risk-based approaches are provided for improving the efficiency of testing, without the need for testers to rely on in-depth knowledge of the product or test code. The tooling is based on existing technologies of code coverage and targeted testing, and can be readily integrated into an existing automated test execution environment.

One embodiment involves importing test case information into a tooling environment based on code coverage and targeted testing, the test information including test name and code coverage data including classes and methods exercised by the code; generating a test hierarchy by analyzing the individual test case information; selecting tests including one or more of: all tests for a full regression run, a subset of tests for basic quality assurance or testing a particular area of functionality, and tests that exercise a recently changed class; executing selected tests to generate a pass/fail result for each test and correlating the test results; and performing test run prioritization to recommend which remaining tests to execute. Referring to the drawings, an implementation is now described.

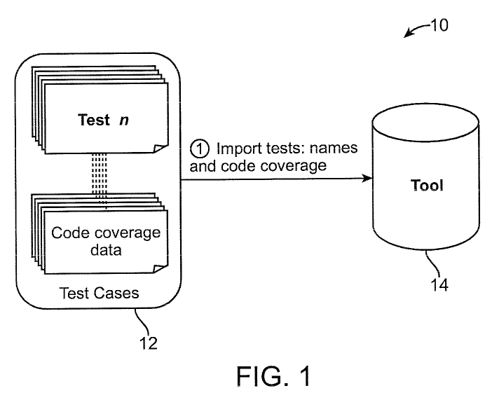

FIG. 1 shows an example import process 10 involving importing test cases 12, including test code and code coverage data, into a tooling environment 14. The required information includes a test name and code coverage data (e.g., the classes and methods exercised by the test code, which can be obtained from standard code coverage tools). Importing test cases and code coverage data into a tooling environment needs to be performed once, although new tests can be added as deltas to the existing data stored in the tool. The tool 14 does not “contain” the tests themselves; rather it simply contains a repository of test names and the functional coverage they exercise.

The tooling automatically constructs the test hierarchy by analyzing the individual test case information. Each test case exists in a hierarchy. More complicated test cases sit at the top, while simple test cases sit at the bottom. Common product functionality exercised by these test cases provides the links in this hierarchy.

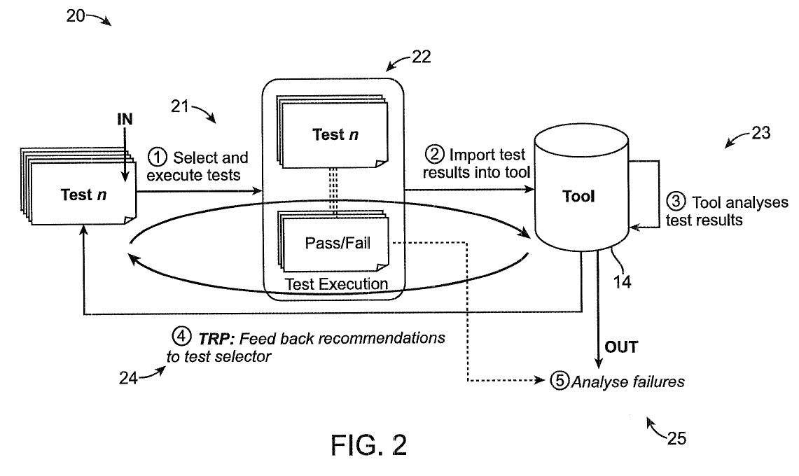

FIG. 2 shows an example text execution process 20. Fully automatic execution of tests involves: (1) in step 21 tests are selected, (2) in step 22 the selected tests are executed and the results are directed to the tool 14, (3) in step 23 the tool 14 analyzes the results, (4) in step 24 the test results are fed back to selector execute more tests, and (5) in step 25 output test results for analysis. The automated iterative procedure between test selection and execution, based on TRP, is shown by the cyclic arrows.

Specifically, once the hierarchy is built up, the tester is ready to run the tests. The tester selects tests to “seed” the tool: ALL tests for a full regression run; SUBSET of tests for basic quality assurance (e.g., build verification test), or testing a particular area of functionality; AUTOMATIC test selection (composition with existing targeted testing technologies, e.g., selecting tests that exercise a recently changed class in the product). The tests are executed and the pass/fail result for each test is routed to the tooling database. The tooling 14 correlates these results with its database of tests and hierarchy, and carries out Test Run Prioritization (TRP) to recommend which remaining tests (un-attempted tests), if any, should be executed. This subsequent execution can lead to a fully automated iterative process as shown in FIG. 2

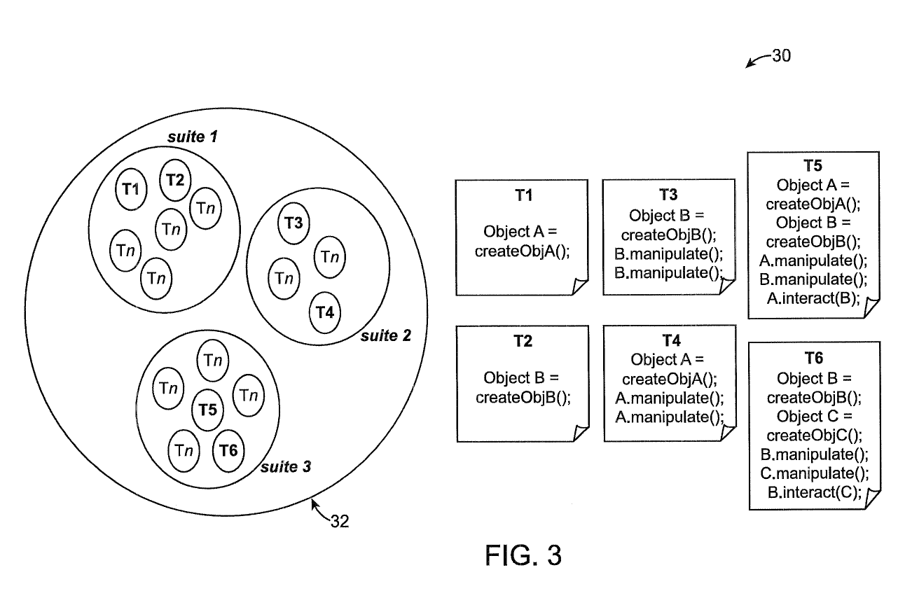

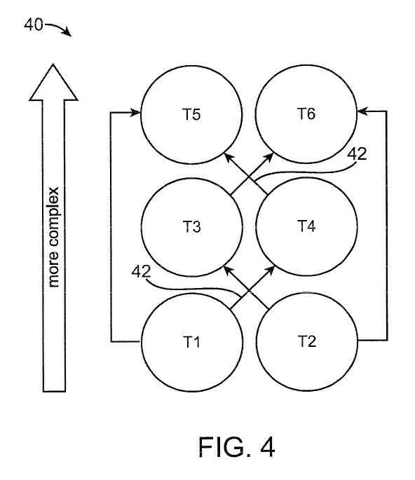

FIG. 3 shows a regression scenario 30, wherein a regression bucket 32 contains three test suites (suite1-suite3) for a product, together with details of test cases (T1-T6) of varying complexity. These test cases exist in a hierarchy 40 shown in FIG. 4. Functional coverage is provided by the tests T1-T6, demonstrating a hierarchy of functional dependence. Bold arrows 42 show an example dependence through a createObjA( ) method.

### Test Run Prioritization (TRP)

In a scenario, the tester elects to execute only one suite (e.g., suite1, FIG. 3). One of these tests, T2, fails. The tester is interested in the impact on the remaining un-attempted tests. This is quantified using TRP which provides a benefit before these tests are even executed. The tooling 14 achieves this by determining the stack dependence of the remaining un-run suites (e.g., suite2 and suite3), and hence makes recommendations on which of these should subsequently be run.

The TRP process recommends not executing tests that have a dependence on T2, or recommends executing tests that do not have a dependence on T2. Any future failures observed in the recommended set are then, by definition, unrelated to the original failure in T2, and hence merit further investigation. As new test failures are recorded, the recommended set is continually modified, narrowing down the number of recommended tests and hence speeding up the test. Thus, the tooling 14 provides dynamic guidance on future test execution (including an ability to act automatically on these recommendations). As a further example, consider a suite of tests with a hierarchy (in ascending order) and test results of: 2 (pass)-74 (not run)-37 (not run)-56 (failed)-91 (not run). In this case, TRP suggests running 74 and/or 37 to get more information on where the defect causing 56 to fail has been introduced. If there are many un-run tests “between” a passing and failing test, various algorithms may be used to select the next test to run. For example, select a test “half way” between the failing and passing tests. If this passes, try a later test but if it fails, try an earlier one, providing an iterative procedure.

Composition with Existing Targeted Testing

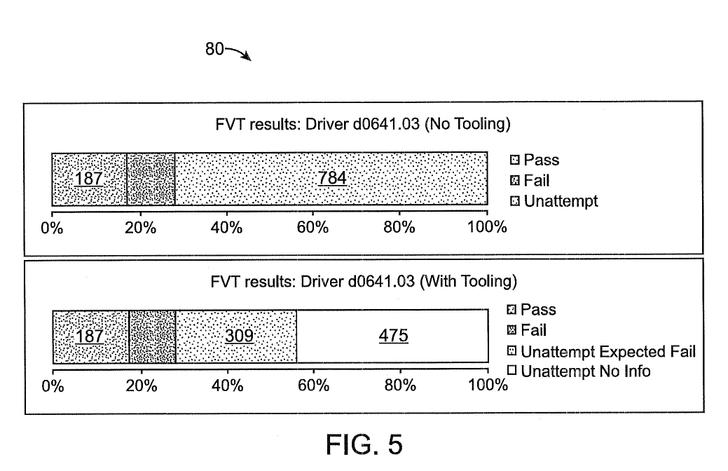

The tooling 14 may be integrated with the existing targeted testing approaches, which examine the code changes in each new product build, identifying the necessary test suites that exercise the changed functionality. The tooling 14 may be added as a simple extension. If a large number of test suites are identified for execution (through large scale code changes in the product, or a slow build up of risk), TRP may also be employed to drive execution in an iterative procedure as described above, dropping suites as necessary based on earlier results. TRP “predicts” which test cases will fail. This can add value to test result reporting; in addition to the traditional “passed, failed and un-attempted” states of reported tests, predictions can be made on the number of expected failures in the remaining un-attempted tests (assuming no further defects). This provides a valuable indicator of driver quality, without the need for 100% test execution, by providing a further state of “expected fail”. FIG. 5 shows an example user interface 80 of providing improved indicators of product quality through calculation of expected test failures. It provides a visual indication of the impact of failing tests.

The invention further provides a method and system for generating test case hierarchies for software code testing in an automated test execution environment. Referring back to FIG. 1, test cases 12, including test code and code coverage data, are imported into a tooling environment 14. The required information includes a test name and code coverage data (e.g., the classes and methods exercised by the test code, which can be obtained from standard code coverage tools). Importing test cases and code coverage data into a tooling environment needs to be performed once, although new tests can be added as deltas to the existing data stored in the tool. The tool 14 does not “contain” the tests themselves; rather it simply contains a repository of test names and the functional coverage they exercise.

### Hierarchy Generation

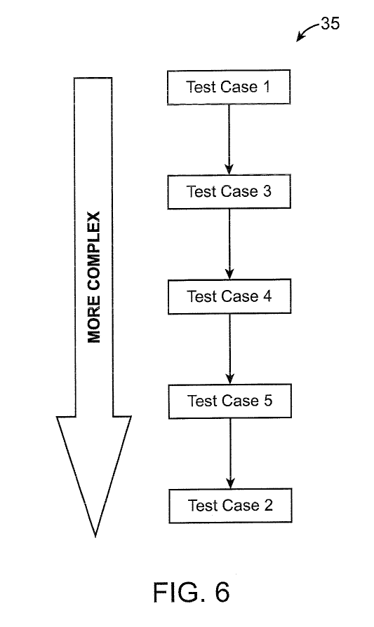

In another example, consider a hierarchy 35 shown in FIG. 6 of five tests T1-T5, demonstrating a hierarchy of functional dependence. One implementation involves determining the hierarchy; determining complexity of a given test case in a regression bucket based on code coverage data comprising methods exercised in a test case and number of lines of code in those methods; defining absolute positions in the hierarchy by the relative complexity of each test case; and extracting a test hierarchy based on code coverage data for test cases executing a common area of software code and said complexity measurements, for each of multiple tests in the regression bucket.

One example involves a “Test Case 1” (FIG. 6) that exercises one Java method. Any other test in the regression bucket that also exercises this method is deemed to be in the same hierarchy as Test Case 1. In the example shown in FIG. 3, this corresponds to Test Case 2, Test Case 3, Test Case 4 and Test Case 5. In one example, the absolute position in the hierarchy is defined by the relative complexity of each test case, an example of which is the number of lines of code (LoC) exercised. Note that complexity measurements other than LoC can be defined (e.g., length of time taken to execute, etc.).

In the example above, Test Case 1 exercises the fewest LoC, and Test Case 2 the most. FIGS. 10-11 show flowcharts of blocks of processes for determining test case hierarchy, according to the invention. In one example, the hierarchy determination steps are implemented by the tooling 14 (FIG. 1).

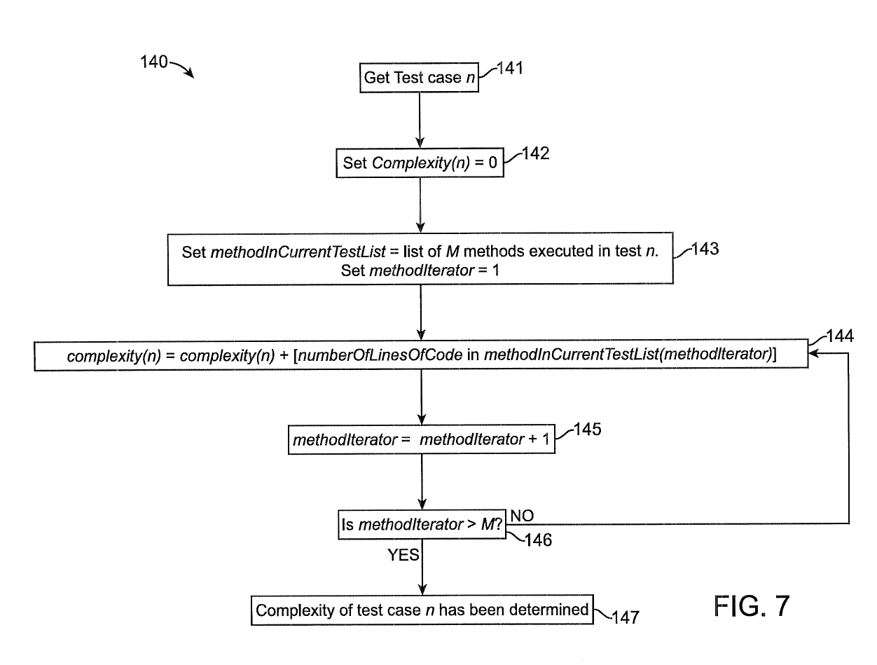

FIG. 7 shows a process 140 for determining the complexity of a given test case in a regression bucket, according to an embodiment of the invention. As alluded above, code coverage data are used to extract the metrics methodInCurrentTestList (i.e., the methods exercised in a test case) and numberOfLinesOfCode (i.e., the number of lines of code in those methods). The process 140 includes the following functional blocks:
Block 141: Get Test case n.
Block 142: Set complexity(n)=0.
Block 143: Set methodInCurrentTestList=list of M methods executed in test n; set methodIterator=1.
Block 144: complexity(n)=complexity (n)+[NumberOfLinesofCode in methodInCurrentTestList(methodIteraor)].
Block 145: methodIterator=methodIterator+1.
Block 146: If methodIterator>M, go to block 147, else go back to block 144.
Block 147: Complexity of test case n has been determined.

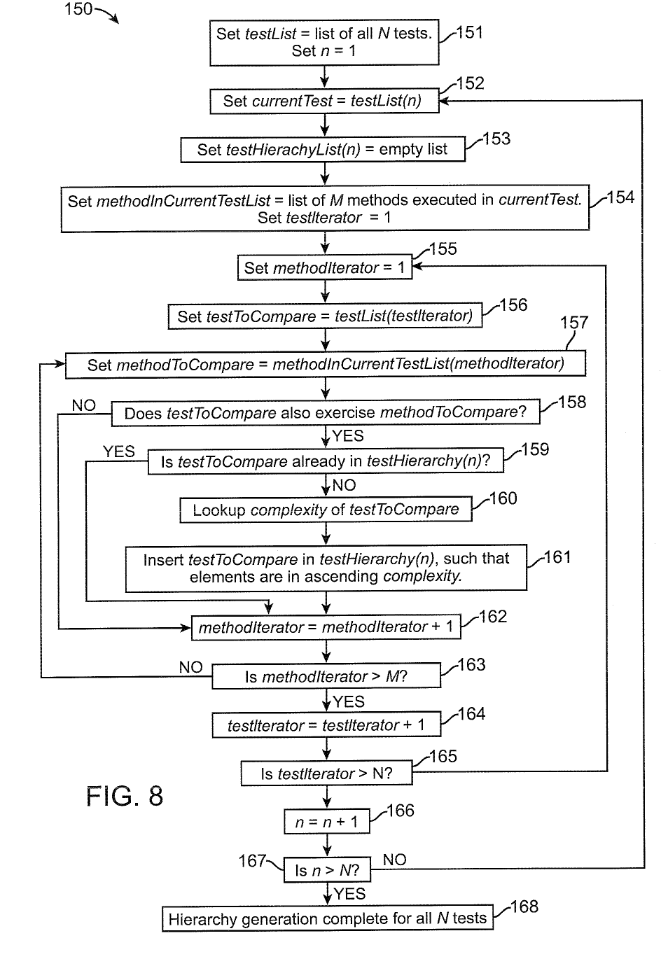

FIG. 8 shows a process 150 for determining test hierarchies, according to an embodiment of the invention. The complexity measurements of each test case from process 40 above are used to calculate test hierarchies for each of the N test cases in the regression bucket. In this example, the full cycle is shown, iterating over each of the N test cases. Code coverage metrics are again utilized to understand whether two test cases exercise the same method (e.g., does testToCompare also exercise methodToCompare?). Again, these data are readily obtainable using current code coverage tools. The process 150 includes the following blocks:
Block 151: Set testList=List of all N tests; Set n=1.
Block 152: Set currentTest=testList(n).
Block 153: Set testHierarchy List(n)=empty list.
Block 154: Set methodInCurrentTestList=list of M methods executed in current tests; Set testIterator=1.
Block 155: Set methodIterator=1.
Block 156: Set testToCompare=testList (testIterator).
Block 157: Set methodToCompare=methodInCurrentTestList (methodIterator).
Block 158: Does testToCompare also exercise methodToCompare? If yes, go to block 159, else go to block 162.
Block 159: Is testToCompare already in testHierarchy(n)? If yes, go to block 162, else go to block 160.
Block 160: Look up complexity of testToCompare as computed in process 140.
Block 161: Insert testToCompare in testHierarchy(n), such that elements are in ascending complexity.
Block 162: methodIterator=methodIterator+1.
Block 163: Is methodIterator>M? If not, go back to block 157, else go to block 164.
Block 164: testIterator=testIterator+1.
Block 165: Is testIterator>N? If not, go back to block 155, else go to block 166.
Block 166: n=n+1.
Block 167: Is n>N? If not, go back to block 152, else go to block 168.
Block 168: Hierarchy generation complete for all N tests.

As is known to those skilled in the art, the aforementioned example embodiments described above, according to the present invention, can be implemented in many ways, such as program instructions for execution by a processor, as software modules, as computer program product on computer readable media, as logic circuits, as silicon wafers, as integrated circuits, as application specific integrated circuits, as firmware, etc. Though the present invention has been described with reference to certain versions thereof; however, other versions are possible. Therefore, the spirit and scope of the appended claims should not be limited to the description of the preferred versions contained herein.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A method of software code testing for an automated test execution environment, comprising:
importing test case information into a tooling environment based on code coverage and targeted testing, the test information including test name and code coverage data including classes and methods exercised by the code;
generating a test hierarchy by analyzing the individual test case information;
selecting tests including one or more of: all tests for a full regression run, a subset of tests for basic quality assurance or testing a particular area of functionality, and tests that exercise a recently changed class;
executing selected tests to generate a pass/fail result for each test and correlating the test results; and
performing test run prioritization to recommend which remaining tests to execute.
